(19) United States
(12) Patent Application Publication
(10) Pub. No.: US 2026/0333149 A1
(43) Pub. Date: Oct. 22, 2026

(54) HANDOVER ENHANCEMENTS

(71) Applicant: Nokia Technologies Oy, Espoo (FI)

(72) Inventors: Xiang XU, Beijing (CN); Ling YU, Espoo (FI); Vinh VAN PHAN, Oulu (FI); György Tamás WOLFNER, Budapest (HU); Faranaz SABOURI-SICHANI, Aalborg (DK); Ravi Prasad R K, Bangalore (IN)

(21) Appl. No.: 19/119,543

(22) PCT Filed: Oct. 11, 2022
(86) PCT No.: PCT/CN2022/124550

§ 371 Date: Apr. 9, 2025

(51) Int. Cl. H04W 36/00; H04W 88/04

(52) U.S. Cl. CPC H04W 36/0072; H04W 36/0079; H04W 36/033; H04W 88/04

(57) ABSTRACT

Example embodiments of the present disclosure relate to handover enhancements. In response to receiving a first message from a third device, for initiating a handover related to a first device and a second device, the first device performs a handover procedure to a target cell indicated in the first message. The first device acts as a UE-to-network relay for the second device to communicate with the third device. The first device then transmits, to the second device, at least one indication based on the handover procedure. In this way, the remote UE is capable of applying different operations based on respective indications associated with a handover result. As a result, the operation of the remote UE can be aligned with the operation of the relay UE in case of performing the handover, and the system performance and reliability can be improved.

### FIELD

Various example embodiments of the present disclosure generally relate to the field of telecommunication and in particular, to methods, devices, apparatuses and computer readable storage medium for handover enhancements.

### BACKGROUND

In a scenario of sideink relay, at least one remote UE may be connected to the network via a relay UE, which is also called a UE-to-Network Relay UE. For example, the remote UE may be wearable devices (e.g., smart watch, glasses, etc.). In case of mobility, the relay UE and the connected remote UE(s) are moved together from one gNB (i.e., a source gNB) to another gNB (i.e., a target gNB), and the remote UE remains connected to the same relay UE. Depending on the operator policy or configurations, the PC5 configuration may or may not be the same in the source gNB and the target gNB. Therefore, the remote UE and the relay UE may use different RRC configuration, for example, security key for communication with the source gNB and the target gNB.

### SUMMARY

In general, example embodiments of the present disclosure provide a solution of handover enhancements.

In a first aspect of the present disclosure, there is provided a first device. The first device comprises at least one processor; and at least one memory storing instructions that, when executed by the at least one processor, cause the first device at least to perform: in response to receiving a first message from a third device, for initiating a handover related to the first device and a second device, performing, at the first device, a handover procedure to a target cell indicated in the first message, the first device acting as a UE-to-network relay for the second device to communicate with the third device; and transmitting, to the second device, at least one indication based on the handover procedure.

In a second aspect of the present disclosure, there is provided a second device. The second device comprises at least one processor; and at least one memory storing instructions that, when executed by the at least one processor, cause the second device at least to perform: receiving, from a third device via a first device, a second message comprising at least one candidate cell configuration and a set of conditions associated with the first device, the first device acting as a UE-to-network relay for the second device to communicate with the third device; and receiving, from the first device, at least one indication corresponding to at least one of the set of conditions.

In a third aspect of the present disclosure, there is provided a third device. The third device comprises at least one processor; and at least one memory storing instructions that, when executed by the at least one processor, cause the third device at least to perform: in accordance with a determination that a handover related to a first device and a second device is to be performed, generating a second message comprising at least one candidate cell configuration and a set of conditions associated with the first device, the first device acting as a UE-to-network relay for the second device to communicate with the third device, and each of the set of conditions corresponding to at least one indication to be transmitted from the first device to the second device; transmitting the second message to the second device via the first device; and transmitting, to the first device, a first message for initiating the handover.

In a fourth aspect of the present disclosure, there is provided a method. The method comprises: in response to receiving a first message from a third device for initiating a handover related to a first device and a second device, performing, at the first device, a handover procedure to a target cell indicated in the first message, the first device acting as a UE-to-network relay for the second device to communicate with the third device; and transmitting, to the second device, at least one indication based on the handover procedure.

In a fifth aspect of the present disclosure, there is provided a method. The method comprises: receiving, from a third device via a first device, a second message comprising at least one candidate cell configuration and a set of conditions associated with the first device, the first device acting as a UE-to-network relay for the second device to communicate with the third device; and receiving, from the first device, at least one indication corresponding to at least one of the set of conditions.

In a sixth aspect of the present disclosure, there is provided a method. The method comprises: in accordance with a determination that a handover related to a first device and a second device to be performed, generating, at a third device, a second message comprising at least one candidate cell configuration and a set of conditions associated with the first device, the first device acting as a UE-to-network relay for the second device to communicate with the third device, and each of the set of conditions corresponding to at least one indication to be transmitted from the first device to the second device; transmitting the second message to the second device via the first device; and transmitting, to the first device, a first message for initiating the handover.

In a seventh aspect of the present disclosure, there is provided a first apparatus. The first apparatus comprises: means for in response to receiving a first message from a third apparatus for initiating a handover related to the first apparatus and a second apparatus, performing a handover procedure to a target cell indicated in the first message, the first apparatus acting as a UE-to-network relay for the second apparatus to communicate with the third apparatus; and means for transmitting, to the second apparatus, at least one indication based on the handover procedure.

In an eighth aspect of the present disclosure, there is provided a second apparatus. The second apparatus comprises: means for receiving, from a third apparatus via a first apparatus, a second message comprising at least one candidate cell configuration and a set of conditions associated with the first apparatus, the first apparatus acting as a UE-to-network relay for the second apparatus to communicate with the third apparatus; and means for receiving, from the first apparatus, at least one indication corresponding to at least one of the set of conditions.

In a nineth aspect of the present disclosure, there is provided a third apparatus. The third apparatus comprises: means for in accordance with a determination that a handover related to a first apparatus and a second apparatus to be performed, generating a second message comprising at least one candidate cell configuration and a set of conditions associated with the first apparatus, the first apparatus acting as a UE-to-network relay for the second apparatus to communicate with the third apparatus, and each of the set of conditions corresponding to at least one indication to be transmitted from the first device to the second device; means for transmitting the second message to the second apparatus via the first apparatus; and means for transmitting, to the first apparatus, a first message for initiating the handover.

In a tenth aspect of the present disclosure, there is provided a computer readable medium. The computer readable medium comprises instructions stored thereon for causing an apparatus to perform at least the method according to any of the fourth aspect, the fifth aspect, or the sixth aspect.

It is to be understood that the Summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example communication environment in which example embodiments of the present disclosure can be implemented;

FIG. 2 illustrates a signaling chart for a handover of a first device and a second device according to some example embodiments of the present disclosure;

FIG. 3 illustrates a flowchart of a method implemented at a first device according to some example embodiments of the present disclosure;

FIG. 4 illustrates a flowchart of a method implemented at a second device according to some example embodiments of the present disclosure;

FIG. 5 illustrates a flowchart of a method implemented at a third device according to some example embodiments of the present disclosure;

FIG. 6 illustrates a simplified block diagram of a device that is suitable for implementing example embodiments of the present disclosure; and

FIG. 7 illustrates a block diagram of an example computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used herein, “at least one of the following: <a list of two or more elements> and “at least one of <a list of two or more elements> and similar wording, where the list of two or more elements are joined by “and” or “or”, means at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or a radio access network (RAN) node or an access point (AP), for example, a node B (NodeB or NB), an evolved NodeB (eNodeB or eNB), a Next Generation NodeB (NR NB or gNB), a Remote Radio Unit (RRU), a radio header (RH), a remote radio head (RRH), Integrated Access and Backhaul (IAB) node, a relay, a low power node such as a femto, a pico, and so forth, depending on the applied terminology and technology. The network device is allowed to be defined as part of a gNB such as for example in CU/DU split in which case the network device is defined to be either a gNB Central Unit (gNB-CU) or a gNB Distributed Unit (gNB-DU).

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

### Example Environment

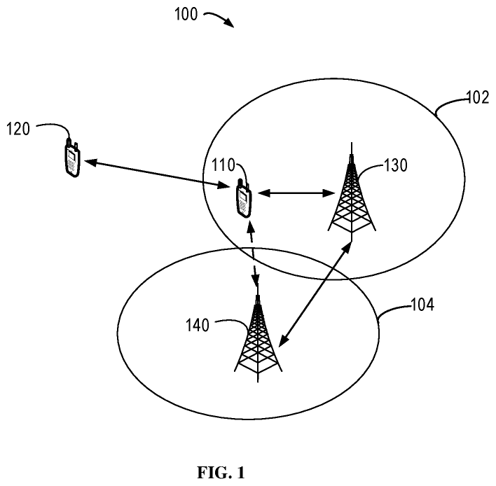

FIG. 1 illustrates an example communication environment 100 in which example embodiments of the present disclosure can be implemented. The communication environment 100 may be a communication system supporting sidelink relay. As shown in FIG. 1, the communication environment 100 includes a first device 110, a second device 120, a third device 130, and a fourth device 140.

The first device 110 and the second device 120 may be terminal devices, such as, UEs. In particular, the first device 110 acts as a relay UE, which may be also called UE-to-Network Relay UE. The second device 120 acts as a remoted UE, such as a smart watch, glasses, and so on. Hereinafter, the first device 110 and the second device 120 may be also called the relay UE 110 and the remote UE 120, respectively.

The third device 130 and the fourth device 140 may be network devices, such as, gNBs, transmit receive points (TRPs), etc., which provide cells 102 and 104 respectively for radio coverage. In the example shown in FIG. 1, the first device 110 is originally located within the cell 102, and served by the third device 130. The second device 120 is outside the cell 102, and connected to the network via the relay UE 110. Alternatively, as another example, the second device 120 may be inside the cell 102 but connected to the network via an indirect path via the relay UE 110. The first device 110 and the second device 120 may communicate with each other via the PC5 interface.

The fourth device 140 provides a neighbor cell 104. Hereinafter, the third device 130 and the fourth device 140 may be also called a serving gNB 130 or a source gNB 130, and a target gNB 140, respectively. Moreover, the cells 102 and 104 may be also referred to as a serving cell 102, and a neighbor cell 104 or a target cell 104, respectively. In the example shown in FIG. 1, the first device 110 is able to perform a handover from the serving cell 102 to the neighbor cell 104. The first device 110 may communicate with the third device 130 or the fourth device 140 via the Uu interface.

In some example embodiments, a link from a terminal device to a network device is referred to as an uplink (UL). Additionally, a link from the network device to the terminal device is referred to as a downlink (DL).

It is to be understood that the number of devices and their connections shown in FIG. 1 are only for the purpose of illustration without suggesting any limitation. The communication network 100 may include any suitable number of devices configured to implementing example embodiments of the present disclosure. Although not shown, it would be appreciated that one or more additional devices and connections may be deployed in the communication network 100.

In the following, for the purpose of illustration, some example embodiments are described with the first device 110 and the second device 120 operating as terminal devices (e.g., UEs) and the third device 130 and fourth device 140 operating as network devices (e.g., gNBs, TRPs, etc.). However, in some example embodiments, operations described in connection with the terminal device may be implemented at a network device or other device, and operations described in connection with the network device may be implemented at a terminal device or other device.

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

To handover at least one remote UE to a target RAN node, the source RAN node transmits a handover (HO) command to the at least one remote UE via the relay UE. The HO command may be carried in a radio resource control (RRC) reconfiguration message. This is performed when the relay UE still is connected with the source cell. However, if the at least one remote UE applies a new RRC configuration (e.g., new security key related to the target RAN node) immediately upon receiving the HO command, it may cause a problem that the at least one remote UE's traffic transmitted based on the new RRC configuration cannot be forwarded to the target RAN node in a case that the relay UE has not performed HO to the target cell itself.

For example, the relay UE may detach from source cell quite late after transmitting the RRC reconfiguration to the remote UE. Additionally, or alternatively, the relay UE may fail to connect to target RAN node and need to reestablish RRC connection with a different RAN node. This causes the remote UE incorrectly applies the RRC reconfiguration which should be used for communication with the target RAN node when the remote UE still communicates with the source RAN node via the relay UE. Furthermore, the source RAN node needs to ensure that the reconfiguration for the connected remote UEs is issued just before the reconfiguration for the relay UE. In some cases that the radio signal may be degraded quickly, there is no guarantee that all connected remote UEs receive the RRC reconfiguration just before the relay UE detaches from the source cell.

Hence, it is expected that the relay UE and the at least one remote UE could be handed over to the target cell together, and apply RRC configuration regarding the source cell or target cell in a synchronized manner.

### Work Principle and Example Signaling for Communication

According to some example embodiments of the present disclosure, there is provided a HO solution. In this solution, in response to receiving a first message from a third device, for initiating a HO related to the first device and a second device, a first device performs a HO procedure to a target cell indicated in the first message. The first device acts as a UE-to-network relay for the second device to communicate with the third device. The first device then transmits, to the second device, at least one indication based on the HO procedure.

With the solution, at least one candidate cell configuration and a set of conditions associated with the relay UE are provided to the at least one remote UE. The set of conditions includes at least a set of PC5 conditions or events. In a case where the source gNB initiates a HO procedure, the relay UE can transmit an indication of a PC5 condition or event which is associated with the HO procedure. Accordingly, a corresponding configuration will be triggered at the remote UE. In this way, the relay UE and the remote UE can be aligned for their actions on performing HO and applying the corresponding configuration regarding the source cell or target cell.

Example embodiments of the present disclosure will be described in detail below with reference to the accompanying drawings.

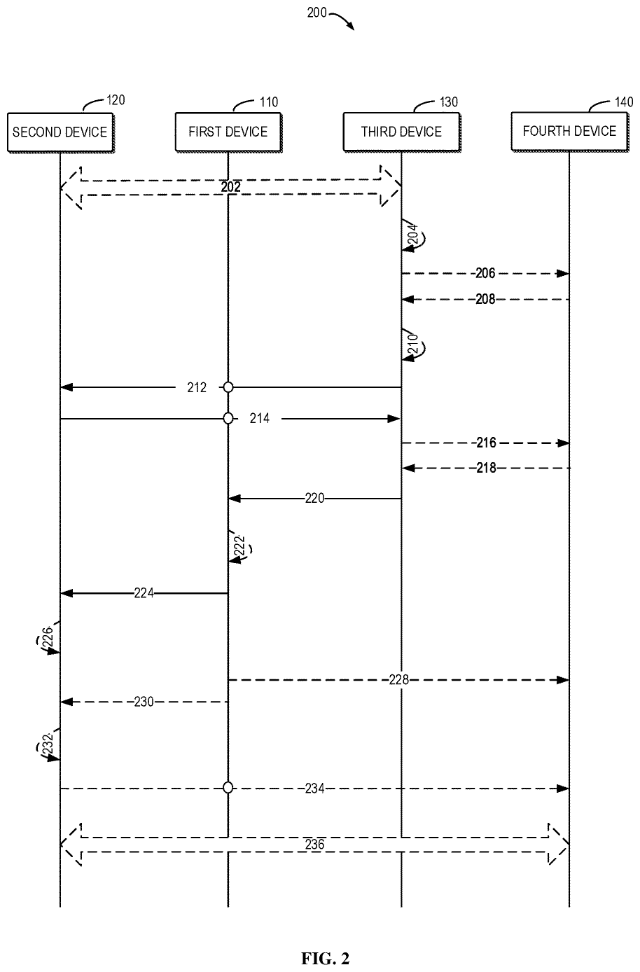

Reference is now made to FIG. 2, which illustrates a signaling chart for a handover of a first device and a second device according to some example embodiments of the present disclosure. As shown in FIG. 2, the process 200 involves the first device 110, the second device 120, the third device 130 and the fourth device 140. For the purpose of discussion, reference is made to FIG. 1 to describe the signaling flow 200.

In the process 200, the second device 120 (i.e., the remote UE) is originally connected to third device 130 (i.e., the source gNB) via the first device 110 (i.e., the relay UE). Therefore, UL and DL data between the second device 120 and the third device 130 are communicated 202 via the first device 110.

The third device 130 determines 204 that a HO related to the first device 110 and the second device 120 is to be performed. In some example embodiments, such a HO decision may be made based on a “group” indication from the second device 120, or from the first device 110, or from the Core Network (CN).

In some example embodiments, the third device 130 may initiate 206 a HO preparation procedure for the second device 120 by transmitting a HO request message to a neighbor gNB, e.g., the fourth device 140. The HO request message may include the “group” indication, and the information of the first device 110.

In some example embodiments, the fourth device 140 may accept the HO by replying 208 the third device 130 with a HO request acknowledge message.

Upon receipt of the HO request acknowledge message, the third device 130 generates 210 a second message comprising at least one candidate cell configuration and a set of conditions associated with the first device 110. The second message may be, for example, a RRC reconfiguration message, which can be considered as a conditional RRCReconfiguration message.

The set of conditions may comprise a set of PC5 conditions or events. In some example embodiments, the third device 130 may decide to add the set of PC5 conditions in the RRC reconfiguration message. This may be added in addition to or instead of conditions based on Uu measurements in normal conditional handover (CHO). For example, the RRC reconfiguration message may include both PC5 conditions and Uu conditions.

In some example embodiments, the term “conditional handover” or “CHO” refers to a handover that is executed by the UE when one or more handover execution conditions are met. In particular, the UE starts evaluating at least one execution condition upon receiving the CHO configuration, and stops evaluating the at least one execution condition once a handover is executed.

The PC5 conditions may refer to, for example, conditions used in case that the second device 120 remains connected with the first device 110 and connects with the fourth device 140. The Uu conditions may refer to, for example, conditions used in case that the second device 120 performs indirect to direct path switch and connects with the fourth device 140.

In some example embodiments, the set of conditions may include at least one of the following:
a condition for “suspend UL transmission”, which is also called a first condition associated with suspending a data transmission to the third device 130 via the second device 120: in a case where the first condition is met, the second device 120 suspends the UL transmission over the PC5 interface. The second device 120 may continue the DL reception by using the current RRC reconfiguration, e.g., PC5 configuration and security key related to the third device 130.
a condition for “resume with the new configuration”, which is also called a second condition associated with resuming with one of the at least one candidate cell configuration: in a case where the second condition is met, the second device 120 executes the associated RRC reconfiguration, and resume UL transmission or DL reception by using the new configuration, e.g., PC5 configuration, security key related to the fourth device 140.
a condition for “resume with old configuration”, which is also called a third condition associated with resuming with a source cell configuration: in a case where the third condition is met, the second device 120 discards at least one candidate cell configuration, and resume UL transmission or DL reception by using the old configuration, e.g., security key related to the third device 130.
a condition for “discard and reestablish”, which is also called a fourth condition associated with discarding the at least one candidate cell configuration and initiating a re-establishment procedure: in a case where the fourth condition is met, the second device 120 discards at least one candidate cell configuration, and initiates a RRC reestablishment procedure.

The third device 130 then transmits 212 the second message (e.g., the RRC reconfiguration message) to the second device 120 via the first device 110. In some example embodiments, the second device 120 may buffer the received RRC reconfiguration message including the set of conditions.

Accordingly, the second device 120 may transmit 214 a RRC reconfiguration complete message to the third device 130 via the first device 110.

Upon receipt of the RRC reconfiguration complete message, the third device 130 may initiate a HO preparation procedure for the first device 110 by transmitting 216 the HO request message that includes the “group” indication, and the information of the associated remote UE, i.e., the second device 120.

In response to the HO request message, the fourth device 140 may transmit 218 a HO request acknowledge message to the third device 130.

Accordingly, the third device 130 transmit 220 a first message for initiating the HO to the first device 110. The first message may be, for example, the HO command.

The HO command informs the first device 110 that the HO is performed, and the second device 120 is to be handed over together with the first device 110. In response to the first message, the first device 110 performs 222 the HO procedure to a target cell indicated in the first message. In particular, the first device 110 may detach from the source cell 102. In the example of FIG. 1, the candidate cell may include the neighbor cell 104.

The first device 110 then transmits 224 at least one indication based on the HO procedure to the second device 120. As previously described, the set of conditions may correspond to the at least one indication.

Depending on the indication, the operations of the second device 120 may be different. In some example embodiments, the at least one indication may include an indication of the HO procedure being started at the first device 110. Accordingly, the second device 120 may be informed of the first device 110 being detached from the source cell 102.

Additionally, or alternatively, the at least one indication may include an indication of suspending the UL transmission from the second device 120 to the third device 130 via the first device 110. This indication may be also referred to as a “suspend” indication. As a result, upon reception of this indication from the first device 110 over PC5, the second device 120 may suspend the UL transmission over PC5. The second device 120 may continue the DL reception by applying current RRC configuration (e.g., PC5 configuration and security key related to the serving gNB 130).

It is noted that the HO Command to the second device 120 at step 212 may implicitly or explicitly indicate that the CHO is tied to an ongoing HO of the first device 110. Thus, in some cases, this may allow for skipping the HO start indication from the first device 110 at step 224, as the second device 120 is already aware of the ongoing HO of first device 110 and may already suspend the UL transmission right after receiving the HO Command at step 212. Nevertheless, it is still beneficial to transmit the HO start indication, as a time period between the transmission of the HO Command at step 212 and the transmission of HO start indication may vary. Therefore, the transmission of HO start indication may allow the second device 120 to transmit UL data within this time period. It should be understood that the transmission of HO start indication may be performed before the detachment from the source cell 102 or alternatively in parallel to the detachment from the source cell 102.

In the above embodiments, upon reception of the indication, the second device 120 may detect the first condition for “suspend UL transmission” is met. Accordingly, the second device 120 may suspend 226 the UL transmission. Additionally, in a case where the first device 110 still has buffered DL data for the second device 120, the first device 110 may continue to relay the DL data to the second device 120.

If the HO procedure is successful, the first device 110 may connect to the target cell 104. After the first device 110 connects to the target cell 104, the first device 110 may transmit 228 a HO completion message to the fourth device 140. Additionally, the first device 110 may transmit 230 an indication of resuming with the target cell configuration to the second device 120 over the PC5 interface. This indication informs the second device 120 of applying a buffered configuration related to the target cell 104 and resuming the data and/or signaling transmission and reception with the target cell 104 via the first device 110.

In certain example embodiment, the second device 120 may receive multiple RRCReconfigurations, and each may correspond to a cell of the fourth device 140. In a case where the first device 110 connects with a specific cell of the fourth device 140 and informs the second device 120 of the specific cell, the second device 120 should execute the associated RRCReconfiguration.

Upon receipt of the indication of resuming with the target cell configuration, the second device 120 may detect the second condition for “resume with a new configuration” is met. Accordingly, the second device 120 may execute 232 the previously buffered RRCReconfiguration.

Additionally, in some example embodiments, the second device 120 may then transmit 234 a HO completion message to the fourth device 140 via the first device 110. Accordingly, the UL and DL data are resumed 236 between the second device 120 and the fourth device 140 via the first device 110.

Otherwise, if the first device 110 fails to connect to the target cell 104 at step 222, in other words, the HO procedure is failed, the first device 110 may reconnect with the source cell 102. In this case, the first device 110 may transmit an indication of “resume with an old configuration” the second device 120 over PC5.

In the above embodiments, upon the reception of this indication, the second device 120 may detect the third condition for “resume with an old configuration” is met. In this case, the second device 120 may discard the previously buffered RRCRconfguration of the target cell 104 and resume UL and DL data with the old configuration of the source cell 102.

Alternatively, in some example embodiments, if the first device 110 fails to connect to the target cell 104 at step 222, the first device 110 may not reconnect with the source cell 102, but reconnect with another gNB that is not prepared. In this case, the first device 110 may perform a reestablishment procedure with a cell of the other gNB, and the cell is different from the source cell 102 and the at least one candidate cell. The first device 110 may then transmit an indication of “discard and reestablish” to the second device 120 over PC5, which corresponds to the fourth condition.

In the above embodiments, upon the reception of this indication, the second device 120 may detect the fourth condition for “discard and reestablish” is met. Accordingly, the second device 120 may discard the previously buffered RRCReconfigurations and initiate a RRC reestablishment procedure.

It should be understood that some of the steps in process 200 are optional or can be omitted. Moreover, the order of the steps is given for an illustrative purpose, and a different order of steps or more or less steps may be also applicable for implementing the proposed solution. Thus, the embodiments of the present disclosure are not limited in this regard.

According to the example embodiments of the present disclosure, the handover of the relay UE and the remote UE to the same target gNB can be performed together via a conditional RRCReconfiguration. This conditional RRCReconfiguration is triggered by a PC5 condition or event associated with a HO for the relay UE. As result, the operation of the remote UE can be aligned with the operation of the relay UE in case of performing the handover, and the system performance and reliability can be improved.

### Example Methods

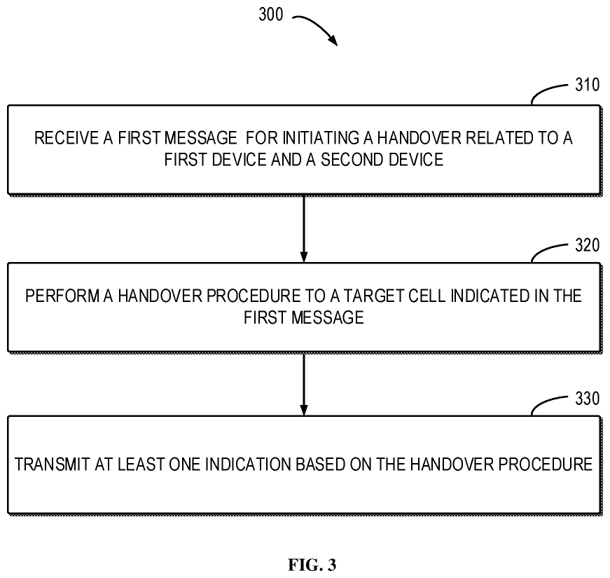

FIG. 3 illustrates a flowchart of a method 300 implemented at a first device according to some example embodiments of the present disclosure. For example, the first device may include a terminal device. For the purpose of discussion, the method 300 will be described from the perspective of the first device 110 in FIG. 1.

At block 310, the first device 110 receives a first message from a third device 130, for initiating a handover related to the first device 110 and a second device 120. The first device 110 acts as a UE-to-network relay for the second device 120 to communicate with the third device 130. The third device 130 may act as a source gNB that provides a serving cell 102 for the first device 110.

In response to receiving the first message, at block 320, the first device 110 performs a handover procedure to a target cell indicated in the first message.

At block 330, the first device 110 transmits, to the second device 120, at least one indication based on the handover procedure.

In some example embodiments, transmitting the at least one indication may comprise: transmitting at least one of the following to the second device 120: an indication of the handover procedure being started at the first device 110, or an indication of suspending an uplink transmission from the second device 120 to the third device 130 via the first device 110.

In some example embodiments, the first device 110 may be further caused to perform: determining that at least one downlink data from the third device 130 to the second device 120 is buffered at the first device 110; and in accordance with the determination that the at least one downlink data is buffered, transmitting the at least one downlink data to the second device 120.

In some example embodiments, transmitting the at least one indication may comprise: determining that the handover procedure is successfully performed to the target cell; and in accordance with the determination that the handover procedure is successfully performed, transmitting an indication of resuming with a target cell configuration to the second device 120, the indication indicating the second device 120 to apply a configuration related to the target cell and resume the data and/or signaling transmission and reception with the target cell via the first device 110.

In some example embodiments, transmitting the at least one indication may comprise: determining that the handover procedure is failed; in accordance with the determination that the first device 110 reconnected with the source cell after handover procedure is failed; and transmitting an indication of resuming with the source cell configuration to the second device 120. The indication may indicate the second device 120 to apply a configuration related to the source cell 102 and resume the data and/or signaling transmission and reception with the source cell via the first device 110.

In some example embodiments, transmitting the at least one indication may comprise: determining that the handover procedure is failed; in accordance with the determination that the handover procedure is failed, performing a reestablishment procedure with a cell other than the source cell and the target cell; and in accordance with a determination that the reestablishment procedure is successfully performed, transmitting a reestablishment indication to the second device 120, the reestablishment indication indicating the second device 120 to discard at least one candidate cell configuration and initiating a re-establishment procedure with the cell via the first device 110.

In some example embodiments, the first device 110 may comprise a relay terminal device. The second device 120 may comprise a remote terminal device. The third device 130 may comprise a network device.

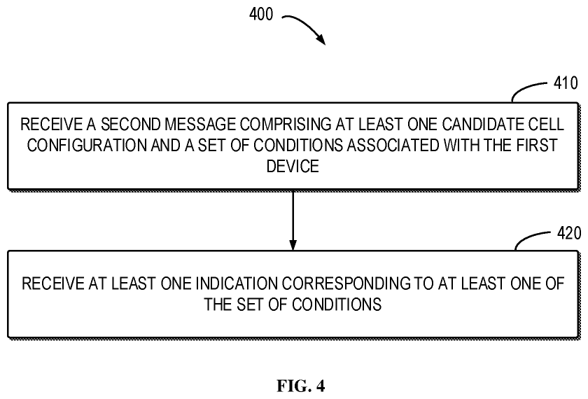

FIG. 4 illustrates a flowchart of an example method 400 implemented at a second device in accordance with some example embodiments of the present disclosure. For example, the second device may include a remote UE that is connected to the network via a relay UE. For the purpose of discussion, the method 400 will be described from the perspective of the second device 120 in FIG. 1.

At 410, the second device 120 receives, from a third device 130 via a first device 110, a second message comprising at least one candidate cell configuration and a set of conditions associated with the first device 110. The first device 110 acts as a UE-to-network relay for the second device 120 to communicate with the third device 130.

In some example embodiments, the second message may comprise a RRC reconfiguration message, and further comprises a measurement configuration related to an interface (e.g., Uu interface) between the second device 120 and the third device 130.

In some example embodiments, the set of conditions may comprise at least one of the following:
a first condition associated with suspending a data transmission to the third device 130 via the first device 110,
a second condition associated with resuming with one of the at least one candidate cell configuration,
a third condition associated with resuming with a source cell configuration,
a fourth condition associated with discarding the at least one candidate cell configuration and initiating a re-establishment procedure.

At 420, the second device 120 receives, from the first device 110, at least one indication corresponding to at least one of the set of conditions.

In some example embodiments, the method 400 further comprises: in response to receiving the second message, determining that the first condition is met; and in accordance with the determination that the first condition is met, suspending the uplink transmission to the third device 130 via the first device 110.

In some example embodiments, receiving the at least one indication comprises: receiving, from the first device 110, an indication of a handover produce being started at the first device 110, the indication corresponding to the first condition.

In some example embodiments, the method 400 may further comprise: in response to receiving the indication corresponding to the first condition, determining that the first condition is met; and in accordance with the determination that the first condition is met, suspending the uplink transmission to the third device 130 via the first device 110.

In some example embodiments, the method 400 may further comprise: receiving, from the first device 110, at least one downlink data transmission transmitted by the third device 130.

In some example embodiments, receiving the at least one indication may comprise: receiving, from the first device 110, an indication of resuming with a target cell configuration, the at least one candidate cell comprising the target cell, and the indication corresponding to the second condition.

In some example embodiments, the method 400 may further comprise: in response to receiving the indication, determining that the second condition is met; in accordance with the determination that the second condition is met, determining the target cell configuration from the at least one candidate cell configuration; and applying the target cell configuration and resuming a data and/or signaling transmission and reception.

In some example embodiments, receiving the at least one indication may comprise: receiving, from the first device 110, an indication of resuming with source cell configuration, the indication corresponding to the third condition.

Additionally, or alternatively, in some example embodiments, the method 400 may further comprise: in response to receiving the indication, determining that the third condition is met; in accordance with the determination that the third condition is met, discarding the at least one candidate cell configuration; and applying the source cell configuration and resuming a data and/or signaling transmission and reception.

In some example embodiments, receiving the at least one indication may comprise: receiving, from the first device 110, a reestablishment indication corresponding to the fourth condition.

In some example embodiments, the method 400 may further comprise: in accordance with the determination that the fourth condition is met, discarding the at least one candidate cell configuration; and initiating a reestablishment procedure.

In some example embodiments, the first device 110 may comprise a relay terminal device. The second device 120 may comprise a remote terminal device. The third device 130 may comprise a network device.

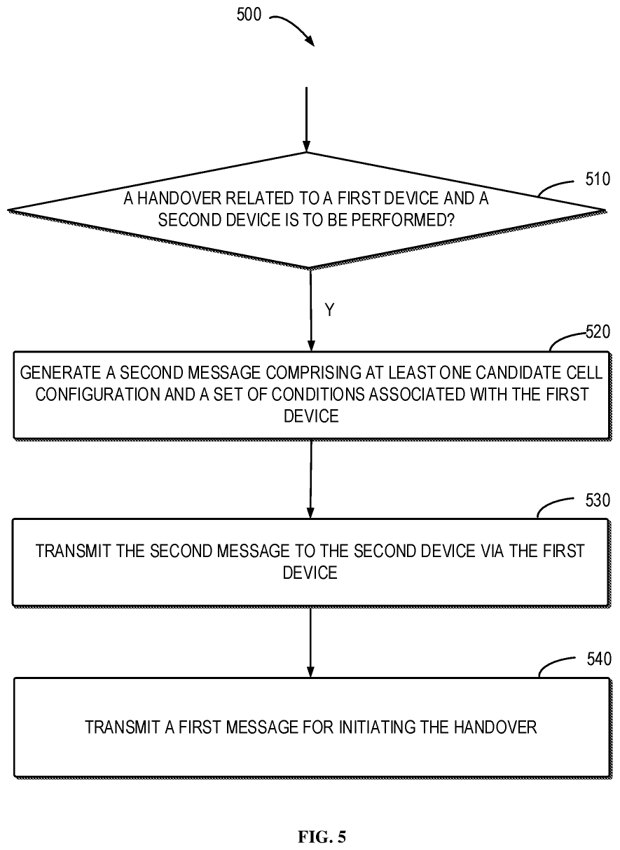

FIG. 5 illustrates a flowchart of an example method 500 implemented at a third device in accordance with some example embodiments of the present disclosure. For example, the third device may include a network device, for example, a serving gNB. For the purpose of discussion, the method 500 will be described from the perspective of the third device 130 in FIG. 1.

At block 510, the third device 130 determines whether a handover related to a first device 110 and a second device 120 is to be performed.

If the handover is to be performed, at block 520, the third device 130 generates a second message comprising at least one candidate cell configuration and a set of conditions associated with the first device 110. The first device 110 acts as a UE-to-network relay for the second device 120 to communicate with the third device 130. Each of the set of conditions corresponds to at least one indication to be transmitted from the first device 110 to the second device 120.

At block 530, the third device 130 transmits the second message to the second device 120 via the first device 110.

At block 540, the third device 130 transmits, to the first device 110, a first message for initiating the handover.

In some example embodiments, the second message may comprise a RRC reconfiguration message, and further comprises a measurement configuration related to an interface between the second device 120 and the third device 130. The interface may be, for example, Uu interface.

In some example embodiments, the set of conditions may comprise at least one of the following:
a first condition associated with suspending a data transmission to the third device 130 via the second device 120,
a second condition associated with resuming with one of the at least one candidate cell configuration,
a third condition associated with resuming with a source cell configuration,
a fourth condition associated with discarding the at least one candidate cell configuration and initiating a re-establishment procedure.

In some example embodiments, the first device 110 may comprise a relay terminal device. The second device 120 may comprise a remote terminal device. The third device 130 may comprise a network device.

### Example Apparatus, Device and Medium

In some example embodiments, a first apparatus capable of performing any of the method 300 (for example, the first device 110 in FIG. 1) may comprise means for performing the respective operations of the method 300. The means may be implemented in any suitable form. For example, the means may be implemented in a circuitry or software module. The first apparatus may be implemented as or included in the first device 110 in FIG. 1.

In some example embodiments, the first apparatus comprises: means for in response to receiving a first message from a third apparatus for initiating a handover related to the first apparatus and a second apparatus, performing a handover procedure to a target cell indicated in the first message, the first apparatus acting as a UE-to-network relay for the second apparatus to communicate with the third apparatus; and means for transmitting, to the second apparatus, at least one indication based on the handover procedure.

In some example embodiments, the means for transmitting the at least one indication comprises: means for transmitting at least one of the following to the second apparatus: an indication of the handover procedure being started at the first apparatus, or an indication of suspending an uplink transmission from the second apparatus to the third apparatus via the first apparatus.

In some example embodiments, the first apparatus further comprises: means for determining that at least one downlink data from the third apparatus to the second apparatus is buffered at the first apparatus; and means for in accordance with the determination that the at least one downlink data is buffered, transmitting the at least one downlink data to the second apparatus.

In some example embodiments, the means for transmitting the at least one indication comprises: means for determining that the handover procedure is successfully performed to the target cell; and means for in accordance with the determination that the handover procedure is successfully performed, transmitting an indication of resuming with a target cell configuration to the second apparatus, the indication indicating the second apparatus to apply a configuration related to the target cell and resume the data and/or signaling transmission and reception with the target cell via the first apparatus.

In some example embodiments, the means for transmitting the at least one indication comprises: means for determining that the handover procedure is failed; means for in accordance with the determination that the first apparatus reconnected with the source cell after handover procedure is failed; and means for transmitting an indication of resuming with the source cell configuration to the second apparatus, the indication indicating the second apparatus to apply a configuration related to the source cell and resume the data and/or signaling transmission and reception with the source cell via the first apparatus.

In some example embodiments, the means for transmitting the at least one indication comprises: mean for determining that the handover procedure is failed; means for in accordance with the determination that the handover procedure is failed, performing a reestablishment procedure with a cell other than the source cell and the target cell; and means for in accordance with a determination that the reestablishment procedure is successfully performed, transmitting a reestablishment indication to the second apparatus, the reestablishment indication indicating the second apparatus to discard at least one candidate cell configuration and initiating a re-establishment procedure with the cell via the first apparatus.

In some example embodiments, the first apparatus comprises a relay terminal device, the second apparatus comprises a remote terminal device, and the third apparatus comprises a network device.

In some example embodiments, a second apparatus capable of performing any of the method 400 (for example, the second device 120 in FIG. 1) may comprise means for performing the respective operations of the method 400. The means may be implemented in any suitable form. For example, the means may be implemented in a circuitry or software module. The second apparatus may be implemented as or included in the second device 120 in FIG. 1.

In some example embodiments, the second apparatus comprises: means for receiving, from a third apparatus via a first apparatus, a second message comprising at least one candidate cell configuration and a set of conditions associated with the first apparatus, the first apparatus acting as a UE-to-network relay for the second apparatus to communicate with the third apparatus; and means for receiving, from the first apparatus, at least one indication corresponding to at least one of the set of conditions.

In some example embodiments, the second message comprises a radio resource control reconfiguration message, and further comprises a measurement configuration related to an interface between the second apparatus and the third apparatus.

In some example embodiments, the set of conditions comprises at least one of the following: a first condition associated with suspending a data transmission to the third apparatus via the first apparatus, a second condition associated with resuming with one of the at least one candidate cell configuration, a third condition associated with resuming with a source cell configuration, a fourth condition associated with discarding the at least one candidate cell configuration and initiating a re-establishment procedure.

In some example embodiments, the second apparatus further comprises: means for in response to receiving the second message, determining that the first condition is met; and means for in accordance with the determination that the first condition is met, suspending the uplink transmission to the third apparatus via the first apparatus.

In some example embodiments, the means for receiving the at least one indication comprises: receiving, from the first apparatus, an indication of a handover produce being started at the first apparatus, the indication corresponding to the first condition.

In some example embodiments, the second apparatus further comprises: means for in response to receiving the indication corresponding to the first condition, determining that the first condition is met; and means for in accordance with the determination that the first condition is met, suspending the uplink transmission to the third apparatus via the first apparatus.

In some example embodiments, the second apparatus further comprises: means for receiving, from the first apparatus, at least one downlink data transmission transmitted by the third apparatus.

In some example embodiments, the means for receiving the at least one indication comprises: means for receiving, from the first apparatus, an indication of resuming with a target cell configuration, the at least one candidate cell comprising the target cell, and the indication corresponding to the second condition.

In some example embodiments, the second apparatus further comprises: means for in response to receiving the indication, determining that the second condition is met; means for in accordance with the determination that the second condition is met, determining the target cell configuration from the at least one candidate cell configuration; and means for applying the target cell configuration and resuming a data and/or signaling transmission and reception.

In some example embodiments, the means for receiving the at least one indication comprises: means for receiving, from the first apparatus, an indication of resuming with source cell configuration, the indication corresponding to the third condition.

In some example embodiments, the second apparatus further comprises: means for in response to receiving the indication, determining that the third condition is met; means for in accordance with the determination that the third condition is met, discarding the at least one candidate cell configuration; and means for applying the source cell configuration and resuming a data and/or signaling transmission and reception.

In some example embodiments, the means for receiving the at least one indication comprises: means for receiving, from the first apparatus, a reestablishment indication corresponding to the fourth condition.

In some example embodiments, the second apparatus further comprises: means for in accordance with the determination that the fourth condition is met, discarding the at least one candidate cell configuration; and means for initiating a reestablishment procedure.

In some example embodiments, the first apparatus comprises a relay terminal device, the second apparatus comprises a remote terminal device, and the third apparatus comprises a network device.

In some example embodiments, a third apparatus capable of performing any of the method 500 (for example, the third device 130 in FIG. 1) may comprise means for performing the respective operations of the method 500. The means may be implemented in any suitable form. For example, the means may be implemented in a circuitry or software module. The second apparatus may be implemented as or included in the third device 130 in FIG. 1.

In some example embodiments, the third apparatus comprises: means for in accordance with a determination that a handover related to a first apparatus and a second apparatus to be performed, generating a second message comprising at least one candidate cell configuration and a set of conditions associated with the first apparatus, the first apparatus acting as a UE-to-network relay for the second apparatus to communicate with the third apparatus, wherein each of the set of conditions corresponds to at least one indication to be transmitted from the first apparatus to the second apparatus; means for transmitting the second message to the second apparatus via the first apparatus; and means for transmitting, to the first apparatus, a first message for initiating the handover.

In some example embodiments, the second message comprises a radio resource control reconfiguration message, and further comprises a measurement configuration related to an interface between the second apparatus and the third apparatus.

In some example embodiments, the set of conditions comprises at least one of the following: a first condition associated with suspending a data transmission to the third apparatus via the second apparatus, a second condition associated with resuming with one of the at least one candidate cell configuration, a third condition associated with resuming with a source cell configuration, a fourth condition associated with discarding the at least one candidate cell configuration and initiating a re-establishment procedure.

In some example embodiments, the first apparatus comprises a relay terminal device, the second apparatus comprises a remote terminal device, and the third apparatus comprises a network device.

FIG. 6 is a simplified block diagram of a device 600 that is suitable for implementing example embodiments of the present disclosure. The device 600 may be provided to implement an electronic device, for example, the first device 110, the second device 120, the third device 130, or the fourth device 140 as shown in FIG. 1. As shown, the device 600 includes one or more processors 610, one or more memories 620 coupled to the processor 610, and one or more communication modules 640 coupled to the processor 610.

The communication module 640 is for bidirectional communications. The communication module 640 has one or more communication interfaces to facilitate communication with one or more other modules or devices. The communication interfaces may represent any interface that is necessary for communication with other network elements. In some example embodiments, the communication module 640 may include at least one antenna.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), an optical disk, a laser disk, and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The instructions of the program 630 may include instructions for performing operations/acts of some example embodiments of the present disclosure. The program 630 may be stored in the memory, e.g., the ROM 624. The processor 610 may perform any suitable actions and processing by loading the program 630 into the RAM 622.

The example embodiments of the present disclosure may be implemented by means of the program 630 so that the device 600 may perform any process of the disclosure as discussed with reference to FIG. 2 to FIG. 5. The example embodiments of the present disclosure may also be implemented by hardware or by a combination of software and hardware.

In some example embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. In some example embodiments, the computer readable medium may include any types of non-transitory storage medium, such as ROM, EPROM, a flash memory, a hard disk, CD, DVD, and the like. The term “non-transitory,” as used herein, is a limitation of the medium itself (i.e., tangible, not a signal) as opposed to a limitation on data storage persistency (e.g., RAM vs. ROM).

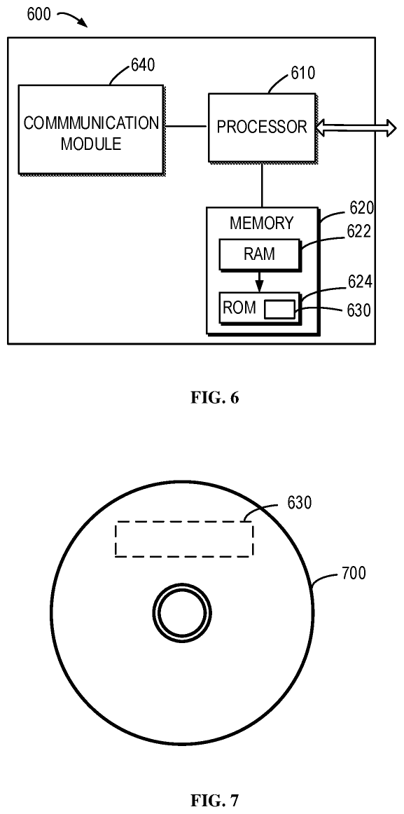

FIG. 7 shows an example of the computer readable medium 700 which may be in form of CD, DVD or other optical storage disk. The computer readable medium 700 has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

Some example embodiments of the present disclosure also provide at least one computer program product tangibly stored on a computer readable medium, such as a non-transitory computer readable medium. The computer program product includes computer-executable instructions, such as those included in program modules, being executed in a device on a target physical or virtual processor, to carry out any of the methods as described above. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. The program code may be provided to a processor or controller of a general purpose computer, special purpose computer, or other programmable data processing apparatus, such that the program code, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program code or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Unless explicitly stated, certain features that are described in the context of separate embodiments may also be implemented in combination in a single embodiment. Conversely, unless explicitly stated, various features that are described in the context of a single embodiment may also be implemented in a plurality of embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

(1-32). (canceled)

33. A first device, comprising:
at least one processor; and
at least one memory storing instructions that, when executed by the at least one processor, cause the first device, at least to perform:
in response to receiving a first message from a third device, for initiating a handover related to the first device and a second device, performing, at the first device, a handover procedure to a target cell indicated in the first message, the first device acting as a UE-to-network relay for the second device to communicate with the third device; and
transmitting, to the second device, at least one indication based on the handover procedure.

34. The first device of claim 33, wherein transmitting the at least one indication comprises:
transmitting, to the second device, at least one of the following:
an indication of the handover procedure being started at the first device, or
an indication of suspending an uplink transmission from the second device to the third device via the first device.

35. The first device of claim 34, wherein the first device is further caused to perform:
determining that at least one downlink data from the third device to the second device is buffered at the first device; and
in accordance with the determination that the at least one downlink data is buffered, transmitting the at least one downlink data to the second device.

36. The first device of claim 33, wherein transmitting the at least one indication comprises:
determining that the handover procedure is successfully performed to the target cell; and
in accordance with the determination that the handover procedure is successfully performed, transmitting an indication of resuming with a target cell configuration to the second device, the indication indicating the second device to apply a configuration related to the target cell and resume the data and/or signaling transmission and reception with the target cell via the first device.

37. The first device of claim 33, wherein transmitting the at least one indication comprises:
determining that the handover procedure is failed; and
in accordance with the determination that the first device is reconnected with the source cell after handover procedure is failed, transmitting an indication of resuming with the source cell configuration to the second device, the indication indicating the second device to apply a configuration related to the source cell and resume the data and/or signaling transmission and reception with the source cell via the first device.

38. The first device of claim 33, wherein transmitting the at least one indication comprises:
determining that the handover procedure is failed;
in accordance with the determination that the handover procedure is failed, performing a reestablishment procedure with a cell other than the source cell and the target cell; and
in accordance with a determination that the reestablishment procedure is successfully performed, transmitting a reestablishment indication to the second device, the reestablishment indication indicating the second device to discard at least one candidate cell configuration and initiating a re-establishment procedure with the cell via the first device.

39. A second device, comprising:
at least one processor; and
at least one memory storing instructions that, when executed by the at least one processor, cause the second device at least to perform:
receiving, from a third device via a first device, a second message comprising at least one candidate cell configuration and a set of conditions associated with the first device, the first device acting as a UE-to-network relay for the second device to communicate with the third device; and
receiving, from the first device, at least one indication corresponding to at least one of the set of conditions.

40. The second device of claim 39, wherein the second message comprises a radio resource control reconfiguration message, and further comprises a measurement configuration related to an interface between the second device and the third device.

41. The second device of claim 39, wherein the set of conditions comprises at least one of the following:
a first condition associated with suspending a data transmission to the third device via the first device,
a second condition associated with resuming with one of the at least one candidate cell configuration,
a third condition associated with resuming with a source cell configuration,
a fourth condition associated with discarding the at least one candidate cell configuration and initiating a re-establishment procedure.

42. The second device of claim 41, wherein the second device is further caused to perform:
in response to receiving the second message, determining that the first condition is met; and
in accordance with the determination that the first condition is met, suspending the uplink transmission to the third device via the first device.

43. The second device of claim 41, wherein receiving the at least one indication comprises:
receiving, from the first device, an indication of a handover produce being started at the first device, the indication corresponding to the first condition.

44. The second device of claim 43, wherein the second device is further caused to perform:
in response to receiving the indication corresponding to the first condition, determining that the first condition is met; and
in accordance with the determination that the first condition is met, suspending the uplink transmission to the third device via the first device.

45. The second device of claim 39, wherein the second device is further caused to perform:
receiving, from the first device, at least one downlink data transmission transmitted by the third device.

46. The second device of claim 39, wherein receiving the at least one indication comprises:
receiving, from the first device, an indication of resuming with a target cell configuration, the at least one candidate cell comprising the target cell, and the indication corresponding to the second condition.

47. The second device of claim 46, wherein the second device is further caused to perform:
in response to receiving the indication, determining that the second condition is met;
in accordance with the determination that the second condition is met, determining the target cell configuration from the at least one candidate cell configuration; and
applying the target cell configuration and resuming a data and/or signaling transmission and reception.

48. The second device of claim 39, wherein receiving the at least one indication comprises:
receiving, from the first device, an indication of resuming with source cell configuration, the indication corresponding to the third condition.

49. The second device of claim 48, wherein the second device is further caused to perform:
in response to receiving the indication, determining that the third condition is met;
in accordance with the determination that the third condition is met, discarding the at least one candidate cell configuration; and
applying the source cell configuration and resuming a data and/or signaling transmission and reception.

50. The second device of claim 39, wherein receiving the at least one indication comprises:
receiving, from the first device, a reestablishment indication corresponding to the fourth condition.

51. The second device of claim 50, wherein the second device is further caused to perform:
in accordance with the determination that the fourth condition is met, discarding the at least one candidate cell configuration; and
initiating a reestablishment procedure.

52. A method comprising:
in response to receiving a first message from a third device for initiating a handover related to a first device and a second device, performing, at the first device, a handover procedure to a target cell indicated in the first message, the first device acting as a UE-to-network relay for the second device to communicate with the third device; and
transmitting, to the second device, at least one indication based on the handover procedure.
